(19) United States
(12) Patent Application Publication
(10) Pub. No.: US 2002/0133613 A1
(43) Pub. Date: Sep. 19, 2002

(54) Gateway metering and bandwidth management

(76) Inventors: Albert Y. Teng, Cupertino, CA (US); Niraj K. Sharma, Cupertino, CA (US); Michael S. Richmond, Beaverton, OR (US); Pingfen Lin, Fremont, CA (US); Animesh Mishra, Milpitas, CA (US)

Correspondence Address: TROP PRUNER & HU, PC, 8554 KATY FREEWAY, SUITE 100, HOUSTON, TX, 77024, US

(21) Appl. No.: 09/811,128

(22) Filed: Mar. 16, 2001

(51) Int. Cl. G06F 15/16; G06F 15/173

(52) U.S. Cl. 709/235; 709/249; 709/224

(57) ABSTRACT

A customer premises gateway including a traffic analyzer with usage tracking to detect fraud such as in the case of masquerading by a router attached to the gateway, and a head-end server including fraud detection and a billing system for providing a maximum bandwidth specifier to the gateway. In the case of Internet Protocol, the traffic and fraud analysis may utilize the address:port combination and also the traffic type specifier to detect fraud and masquerading and to control bandwidth.

### BACKGROUND OF THE INVENTION

1. Technical Field of the Invention

The present invention relates generally to information network traffic, and more specifically to monitoring network traffic for the likelihood of address masquerading.

2. Background Art

FIG. 1 illustrates an exemplary information network system 10 according to the prior art. The system includes a first server (Server A) 12 coupled to a router or gateway 14, which is in turn coupled to a second server (Server B) 16. The connections are, again, constructed using any suitable mechanisms. The first server sends an Original Message to the second server, via the router. The router performs so-called “EP masquerading”, for any of a variety of purposes, such as to increase security by hiding address or identity information of the first server from discovery by the second server. The router receives the Original Message, and sends in its place a Masqueraded Message to the second server. The second server performs whatever operations are required, such as gathering data or making calculations, then sends an Original Reply back to the router, which the second server perceives as being the originator of the request message. The router then unmasquerades the Original Reply, and forwards the Unmasqueraded Reply on to the first server, which receives it as though it had been a direct reply in response to the Original Message.

FIG. 2 illustrates the method by which IP masquerading is done in the router. FIG. 2 has been constructed in columnar fashion, aligned with FIG. 1, such that the reader will appreciate that the operations described in FIG. 2 are accomplished by the information network entity appearing above them in FIG. 1. The first server sends (20) a message (Original Message) to the second server. The first server indicates, in the message, the address to which the request is being sent, and the reply address to which it wants the reply sent. In the case of IP, these addresses take the form of an IP address and a specified port. In the example shown, the “reply-to” address (usually the same as the “from” address) is “A:port X”, and the “to” address is “B:port Y”.

The router receives this request, and replaces (22) the “reply-to” or “from” address with a reply-to or from address of its own, such as “Router:port Z”. It then forwards this Masqueraded Message on to the second server, specifically to “B:port Y”. The Router keeps a record of the address/port substitution which was performed.

The second server receives (24) the Masqueraded message, creates (26) its reply, and sends (28) the reply back to the masqueraded address. The router receives the Original Reply from the second server, replaces (30) the masqueraded address with the original address which was substituted out (at 22), and sends the Unmasqueraded Reply on to the original “reply-to” or “from” address in the Original Message, which is received (32) by the first server.

The second server has no way of knowing who sent the request from behind the router, nor perhaps even any way to know that there was anybody behind the router. This presents some difficulties and challenges in areas such as billing and fraud prevention.

FIG. 3 illustrates an information network system 40 which is susceptible of these flaws, and will be compared with the simplified system of FIG. 1 for illustration. Please refer to both drawings. The system 40 includes customer premises equipment 42. The customer premises equipment includes one or more devices 44 which generally equate to the first server 12, in that these devices may issue requests or Original Messages. These devices may include, for example, one or more PCs 46, one or more appliances 48, and so forth. They may further include one or more gateways or routers 50, behind which are even more devices which may issue Original Messages.

The customer premises equipment further includes a gateway or router 52 which corresponds generally to the router 14, in that it may perform IP masquerading. The router 52 is connected, typically via a digital subscriber line (DSL), a television cable, or other broadband mechanism, to equipment at the premises of a service provider such as an Internet Service Provide (ISP). This ISP Premises equipment 54 may typically include a head-end server 56 to which are attached a multitude of customers' equipment; only a single instance is shown, in the interests of clarity. The head-end server provides account authorization, billing services, and so forth, and also provides a connection to the internet, which is stylistically illustrated as a cloud 58. Also connected to the internet, possibly via similar structures of ISP equipment (not shown), are a multitude of other data information entities, such as web servers, mail servers, and the like. For ease of explanation, these are illustrated by the second server 16 (Server B).

The IP masquerading mechanism of the gateway 52 enables a customer to, for example, connect up several of his neighbors through his single ISP connection. In this case, the various PCs and appliances shown may not be on the same premises as the paying customer. Thus, the ISP loses revenue it might have gained by charging those other “customers” for internet access. This may further cause the ISP other harm, such as compromised security.

The reader will appreciate that the term “server” is used merely by way of example, as are “PC” and “appliance” and so forth. The reader will further appreciate that a “gateway” and a “router” may perform similar functions for the purposes of this disclosure, and that those terms are used somewhat interchangeably. The reader will also understand that the term “internet” has been used only for illustration purposes, and that the following invention is not limited to applications involving servers, the internet, and so forth.

### BRIEF DESCRIPTION OF THE DRAWINGS

The invention will be understood more fully from the detailed description given below and from the accompanying drawings of embodiments of the invention which, however, should not be taken to limit the invention to the specific embodiments described, but are for explanation and understanding only.

FIG. 1 shows an information network system adapted to perform address masquerading, according to the prior art.

FIG. 2 shows a method of operation of the system of FIG. 1, according to the prior art.

FIG. 3 shows an information network system according to the prior art.

FIG. 4 shows one embodiment of an information network system according to the invention.

FIG. 5 shows one embodiment of a method of operation of the system of FIG. 4.

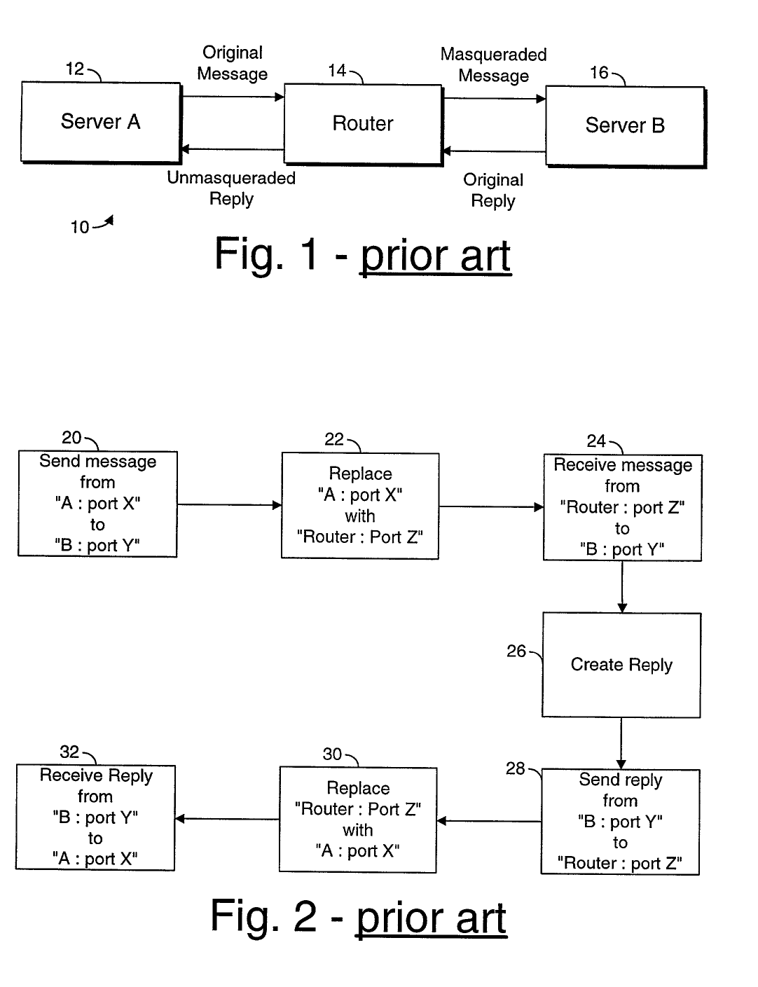

### DETAILED DESCRIPTION

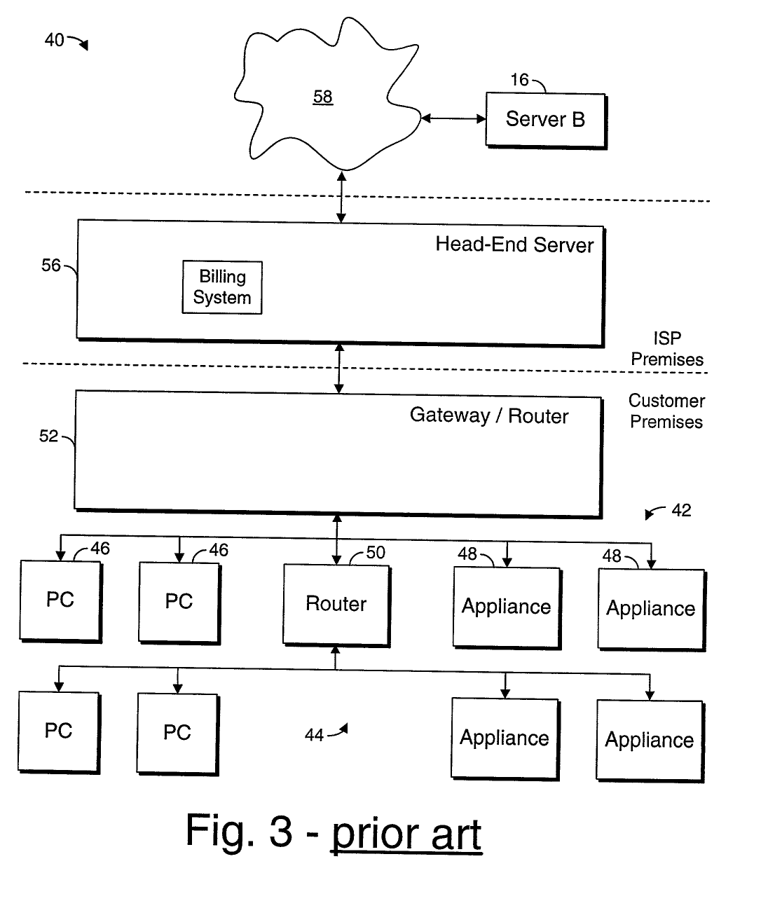

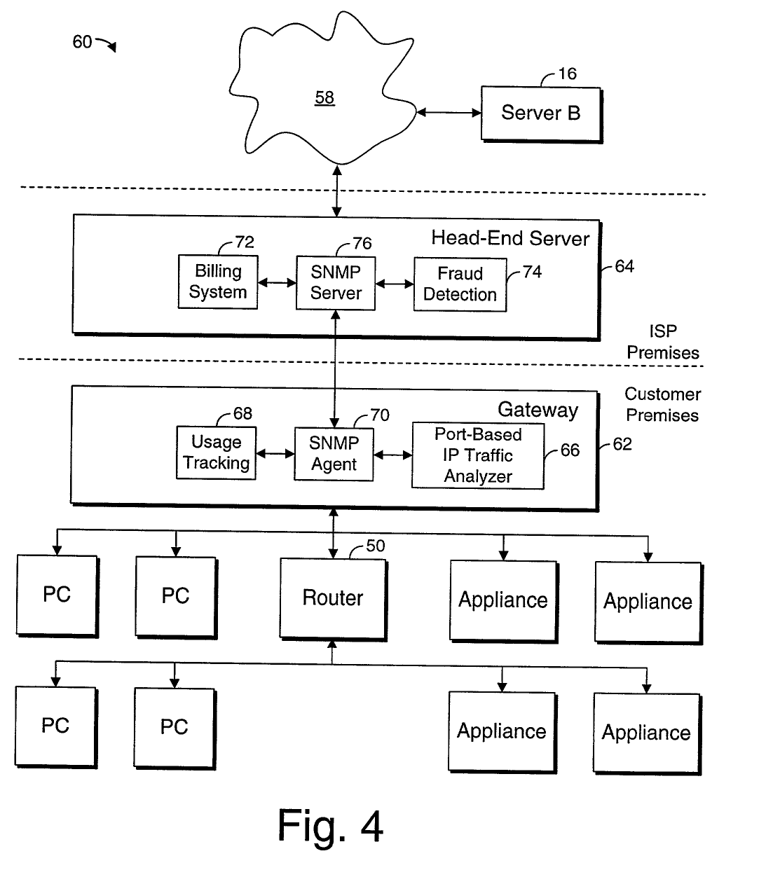

FIG. 4 illustrates one embodiment of an information network system 60 according to the teachings of this invention. The customer premises equipment includes an enhanced gateway or router 62, and the ISP premises equipment includes an enhanced head-end server 64. In some embodiments, the remainder of the system may be substantially as in FIG. 3.

The enhanced gateway or router 62 includes a Port-Based IP Traffic Analyzer 66, a Usage Tracking system 68, and a Simple Network Management Protocol (SNMP) Agent 70. The enhanced head-end server 64 includes a billing system 72, a fraud detection system 74, and an SNMP server 76.

The Port-Based IP Traffic Analyzer makes use of the fact that IP masquerading is generally based upon substituting port numbers (such as “B:port Y” becoming “Router:port Z”). Each device in a given sub-net will have a unique IP address. A communication session between a client and a server in progress concurrently with other communications sessions may have a unique address:port combination in all protocols, such as FTP, HTTP, etc., even in the presence of address masquerading.

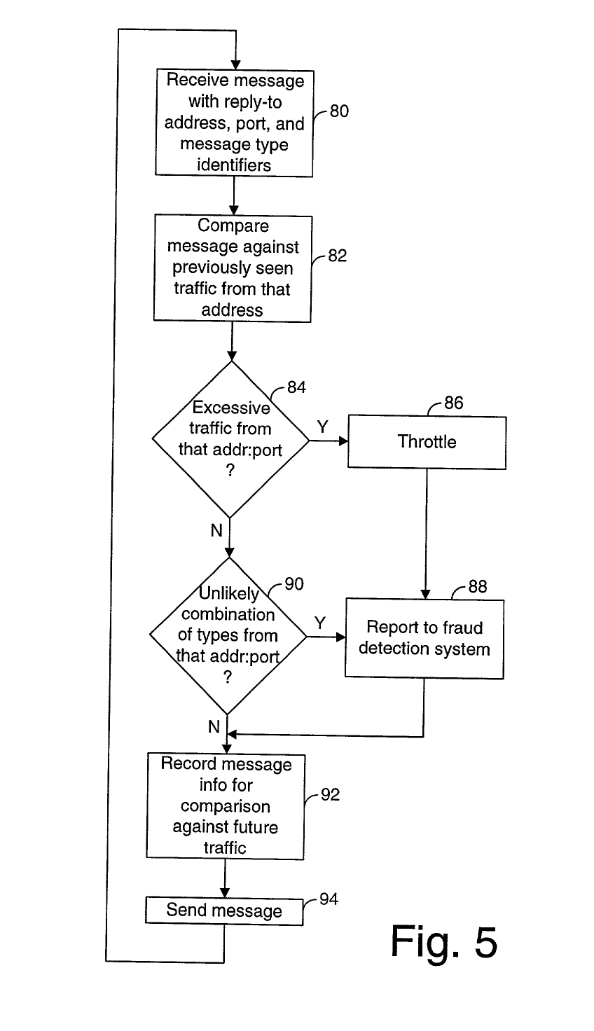

FIG. 5 illustrates one embodiment of a method of operation of the Port-Based IP Traffic Analyzer. Please also continue to refer to FIG. 4. The gateway receives (80) a message which bears a reply-to address, a port specifier, and a message type identifier. The message type identifier may, for example, indicate whether the message is an FTP request, or an HTTP request, and so forth. The Port-Based IP Traffic Analyzer compares (82) these values against previously-received traffic, to identify prior messages from the same address:port combination.

If (84) too much traffic is being seen from that address:port, the gateway will throttle (86) traffic to and/or from that address:port. The decision as to what constitutes “too much” may be made, for example, by the billing system 72, which may convey some maximum traffic value to the gateway via the SNMP server 76 and the SNMP agent 70. This mechanism may be used, for example, in restricting a customer to a maximum level of service (bandwidth) for which he has paid. Typically, ISPs charge different rates for different service bandwidths. If excessive usage is detected, the gateway may further report (88) it to the fraud detection system.

Similarly, the determination (84) of excess traffic, the throttling (86), and/or the reporting (88) may be applied to the whole body of traffic passing through the gateway, and not merely on an address:port basis.

If (90) the Port-Based IP Traffic Analyzer determines that there are an unlikely combination of request types originating from the address:port combination, this may indicate possible fraud, which is reported (88) to the fraud detection system. For example, if both FTP and HTTP traffic appear to be originating from the same address:port, it may mean that the device from which the gateway is directly receiving this traffic is not the actual originator, but, instead that device is likely to be a router (50) which is performing IP masquerading for two or more devices hidden behind it. This may suggest that the customer has sub-networked his neighbors, who are not paying the ISP.

Finally, the gateway will send (94) the message.

The reader will appreciate that, for purposes of clarity and ease of understanding, the invention has been explained with respect to one particular embodiment, and that the invention is not limited to the particular details shown and described. For example, the invention may be used with addressing schemes other than Internet Protocol, and with transport media other than the internet backbone and Ethernet. The term “communication switch” may be used to generically refer to gateways, routers, switches, and the like. The term “port” should be understood to refer to any form of sub-address, not limited to physical ports or IP address ports. The messages such as the Original Message and the Masqueraded Reply may be termed “messages”, while communications such as fraud indications from the gateway to the head-end server and such as data from the head-end server to the gateway setting the gateway's maximum paid-for bandwidth may be termed “alerts”. In order to avoid confusion with the “IP port”, the connections between the head-end server and the gateway, and between the gateway and the PCs etc. may be termed “I/Os” regardless of whether they are implemented as single two-way connections or two one-way connections or even single one-way connections, and regardless of whether they use the same physical connection or the same transport protocol.

The reader should appreciate that drawings showing methods, and the written descriptions thereof, should also be understood to illustrate machine-accessible media having recorded, encoded, or otherwise embodied therein instructions, functions, routines, control codes, firmware, software, or the like, which, when accessed, read, executed, loaded into, or otherwise utilized by a machine, will cause the machine to perform the illustrated methods. Such media may include, by way of illustration only and not limitation: magnetic, optical, magneto-optical, or other storage mechanisms, fixed or removable discs, drives, tapes, semiconductor memories, organic memories, CD-ROM, CD-R, CD-RW, DVD-ROM, DVD-R, DVD-RW, Zip, floppy, cassette, reel-to-reel, or the like. They may alternatively include down-the-wire, broadcast, or other delivery mechanisms such as Internet, local area network, wide area network, wireless, cellular, cable, laser, satellite, microwave, or other suitable carrier means, over which the instructions etc. may be delivered in the form of packets, serial data, parallel data, or other suitable format. The machine may include, by way of illustration only and not limitation: microprocessor, embedded controller, PLA, PAL, FPGA, ASIC, computer, smart card, networking equipment, or any other machine, apparatus, system, or the like which is adapted to perform functionality defined by such instructions or the like. Such drawings, written descriptions, and corresponding claims may variously be understood as representing the instructions etc. taken alone, the instructions etc. as organized in their particular packet/serial/parallel/etc. form, and/or the instructions etc. together with their storage or carrier media. The reader will further appreciate that such instructions etc. may be recorded or carried in compressed, encrypted, or otherwise encoded format without departing from the scope of this patent, even if the instructions etc. must be decrypted, decompressed, compiled, interpreted, or otherwise manipulated prior to their execution or other utilization by the machine.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A communication switch comprising:
at least one input for receiving messages, each message including,
an address specifier, and
a port specifier;
a traffic analyzer for comparing the port specifier of a first message against the port specifiers of previously received messages; and
an output for reporting a result of the comparing.

2. The communication switch of claim 1 further comprising:
a usage tracking system for throttling traffic through the communication switch.

3. The communication switch of claim 2 wherein:
the usage tracking system includes means for throttling traffic according to address specifier and port specifier in combination.

4. The communication switch of claim 2 wherein:
the usage tracking system includes means for throttling traffic according to a predetermined maximum aggregate bandwidth for the communication switch.

5. The communication switch of claim 1 wherein:
the traffic analyzer is further for reporting fraud over the output.

6. The communication switch of claim 1 wherein:
the traffic analyzer is further for comparing the address specifier and port specifier combination of the first message against the address specifier and port specifier combinations of the previously seen messages.

7. The communication switch of claim 1 wherein:
each message further includes,
a traffic type specifier; and
the traffic analyzer is further for comparing the traffic type specifier of the first message against the traffic type specifiers of the previously received messages.

8. The communication switch of claim 1 wherein:
each message further includes,
a traffic type specifier; and
the traffic analyzer is further for comparing the address specifier, port specifier, and traffic type specifier of the first message against the address specifier, port specifier, and traffic type specifier combinations of the previously received messages.

9. A server for use with a communication switch, the server comprising:
an I/O for communicating messages and alerts between the communication switch and the server;
a billing system for providing a maximum bandwidth indication to the communication switch; and
a fraud detection system for receiving fraud alerts from the communication switch.

10. The server of claim 9 wherein:
the fraud detection system is responsive to fraud alerts indicating excessive traffic on an address:port combination at the communication switch.

11. The server of claim 10 wherein:
the fraud detection system is further responsive to fraud alerts indicating a likelihood of IP masquerading.

12. The server of claim 10 wherein:
the fraud detection system is responsive to fraud alerts based upon address:port:type combination.

13. A method comprising:
receiving a message which includes an address:port identifier;
comparing the address:port identifier against previously received messages' address:port identifiers; and
determining whether excessive traffic is originating from a source identified by the address:port identifier.

14. The method of claim 13 further comprising:
throttling message traffic in response to determining that excessive traffic is originating from the source.

15. The method of claim 14 wherein the throttling comprises:
throttling message traffic to and/or from that source.

16. The method of claim 13 wherein the message further includes a type specifier, the method further comprising:
comparing the type specifier against type specifiers of previously received messages from the same address:port as the message; and
determining whether the source is issuing messages of different types such as indicate fraud.

17. The method of claim 16 further comprising:
sending a fraud alert in response to determining that the source is issuing messages of different types such as indicate fraud.

18. The method of claim 13 further comprising:
recording the message for use in future comparisons against future messages.

19. The method of claim 13 further comprising:
receiving an indication of a maximum bandwidth; and
throttling message traffic in response to the indication of the maximum bandwidth.

20. A customer premises gateway for communicating with an ISP premises head-end server, the customer premises gateway comprising:
at least one first I/O each for connecting to a communication device;
a second I/O for connecting to the ISP premises head-end server; and
a traffic analyzer coupled to the at least one first I/O and the second I/O, including
a port identifier comparator,
a throttling mechanism, and
a fraud reporter.

21. The customer premises gateway of claim 20 wherein the traffic analyzer further includes:
a message type analyzer.

22. A machine accessible medium including therein instructions which, when executed by the machine, cause the machine to:
compare a first address:port combination of a message against a second address:port combination of a previously received message; and
responsive to the address:port comparison, determine whether excessive traffic is going to/from the first address:port combination.

23. The machine accessible medium of claim 22 further including therein instructions which, when executed by the machine, cause the machine to further:
throttle traffic to/from the first address:port combination.

24. The machine accessible medium of claim 23 further including therein instructions which, when executed by the machine, cause the machine to further:
report fraud.

25. The machine accessible medium of claim 22 further including therein instructions which, when executed by the machine, cause the machine to further:
compare a first type specifier of the message against a second type specifier of the previously received message; and
responsive to the type specifier comparison, determine whether the first address:port identifies a router performing address:port masquerading.

26. The machine accessible medium of claim 25 further including therein instructions which, when executed by the machine, cause the machine to further:
report the masquerading.

27. A method for a communication switch to detect that a device connected to the communication switch is a router, comprising:
receiving from the device a message including address and sub-address identifiers;
comparing the address and sub-address identifiers against one or more previously received messages; and
detecting that the address and sub-address identifiers indicate that the device is performing masquerading.

28. The method of claim 27 wherein the detecting comprises:
observing a first message type indicator in the message and a different message type indicator in at least one of the previously received messages.

29. The method of claim 27 further comprising:
recording the address and sub-address identifiers of the message;
receiving a second message; and
comparing the second message's address and sub-address identifiers against the recorded address and sub-address identifiers.

30. The method of claim 27 wherein:
the address identifier comprises an Internet Protocol address; and
the sub-address identifier comprises a port number.

31. The method of claim 27 further comprising:
responsive to detecting masquerading, sending a fraud alert to a server.

32. The method of claim 27 further comprising:
throttling message transmission.

33. The method of claim 27 further comprising:
comparing a message type identifier of the message against one or more previously received messages; and
detecting that the message type identifier of the message is different than a message type identifier of a previously received message having a same address identifier and a same sub-address identifier as the message.

34. The method of claim 33 wherein:
the address identifier comprises an Internet Protocol address;
the sub-address identifier comprises a port number; and
the message type identifier comprises one of an HTTP specifier and an FTP specifier.
